(19) United States
(12) Patent Application Publication
(10) Pub. No.: US 2010/0293175 A1
(43) Pub. Date: Nov. 18, 2010

(54) FEATURE NORMALIZATION AND ADAPTATION TO BUILD A UNIVERSAL RANKING FUNCTION

(76) Inventors: Srinivas Vadrevu, Milpitas, CA (US); Belle L. Tseng, Cupertino, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/464,660

(22) Filed: May 12, 2009

(51) Int. Cl. G06F 17/30; G06F 15/18

(52) U.S. Cl. 707/759; 706/12; 707/713; 707/754

(57) ABSTRACT

To increase the amount of training data available to train a machine learning ranking function, data from multiple markets are normalized in such a manner as to optimize a measurement of quality of the ranking function trained on the various sets of normalized training data. Furthermore, the feature scores of training data from individual markets are adapted to conform to the distributions of feature scores from a base market. Such adapted training data from the various markets may be used to train a single, robust ranking function. Adaptation of feature scores in a particular training data set involves mapping feature scores of the particular training data set to feature scores of a base training data set to conform the distributions of the feature scores in the particular training data set to the distributions of the feature scores in the base training data set.

### FIELD OF THE INVENTION

The present invention relates to training data for machine learning models, and, more specifically, to increasing the amount of training data available to train a machine learning model through feature normalization and feature adaptation.

### BACKGROUND

Web search engines are viewed as a window into the vast spectrum of the increasingly popular World Wide Web (the “Web”), and users across the world use search engines to access information and common knowledge on the Web. Search engines, such as the search engine provided by Yahoo!, Inc., provide search results to users in response to queries submitted by those users. Currently, Yahoo!, Inc. maintains distinct search engines for many different markets, usually associated with national regions, that serve local content to the users. For example, uk.search.yahoo.com targets users in the United Kingdom (the U.K.) and Ireland, and search.yahoo.co.jp targets users in Japan.

Because search results may indicate hundreds or thousands of matching documents—i.e. “hits”—for a given query, it is usually helpful to sort those documents by relevance to the query. One technique for sorting documents is to rank the documents according to relevance scores calculated for each document. Search results that have been sorted in this fashion are hereinafter described as “ranked search results.”

One problem with generating ranked search results is that it is difficult to determine meaningful relevance scores for any given document with respect to a given query. A query may be one or more words, phrases, or symbols. Generally, a query is input to a search engine by a user, but may also be generated by other means. Search results may include one or more documents, discovered by a web crawler or by other means, that a search engine returns in response to a given query. Such documents may be accessible over the Web, or may reside on a particular local machine.

One approach for determining relevance scores for documents with respect to a given query relies on human editorial judgments. For example, a search provider may ask a person or group of persons to determine relevance scores for various documents matching a particular query as grouped into query/document pairs. A query/document pair is a matching between a particular document and a particular query that may be evaluated for relevance. A document in a query/document pair may be referenced by a Uniform Resource Locator (URL), or by another means. For example, a particular query/document pair includes the query “Scottish dog” and a document corresponding to www.scottishterrierdog.com, which includes information about Scottish terriers. Such a query/document pair may be labeled by a human as a good or excellent match because of the relevance of information on Scottish terriers to the query “Scottish dog”. Unfortunately, obtaining human editorial judgments for every possible hit for every possible query that may be submitted to a search engine is prohibitively expensive, particularly because documents are continuously modified and/or added to a search repository.

An alternative approach to relying purely on human editorial judgments is to configure a search system to “learn” a ranking function using various machine learning techniques. Such a ranking function returns a relevance score for a particular query/document pair given one or more features of the corresponding query, of the corresponding document, or of the query/document pair. Using machine learning techniques, one may continuously adapt the ranking function as time goes on.

Generally speaking, a machine learning search system is trained on what constitutes relevance using query/document pairs for which relevance scores are already known, for example, based on human editorial judgment. The data used to train a machine learning model is known as “training data”. The search system then uses a classifier, such as a neural network or decision tree, to iteratively refine a function of query/document pair features. The result of this process is a ranking function whose calculated relevance scores maximize the likelihood of producing the “target” relevance scores, i.e., the known relevance scores for each of the query/document pairs in the training data. This ranking function may then be used to compute relevance scores for query/document pairs for which the appropriate relevance scores are not known. Training data may take any of a variety of well-known forms, such as pair-wise data, which may consist of query-document1-document2 data, where document1 is considered more relevant to the given query than document2.

Training data forms the core part of the ranking model underlying such a machine learned ranking function. Thus, if insufficient training data for a specific market is used to train a machine learning model for the market, then the model will be overfitted to the training data. Such a model may not generalize well for query/document pairs that are not part of the training data used to train the model. In contrast, if the training data used to train the model is representative of the majority of query/document pairs that are not in the training data, then the model will be robust and will generalize well. Therefore, a large set of training data, which is more likely to be representative of data not in the training data set, is preferable when training such a machine learning ranking function.

Because training data is usually collected for each region or market separately, the amount of training data that is available from each market is limited and may vary for each individual market. For example, the amount of training data collected for a search engine targeting an Indian market may be significantly smaller than the amount of training data collected for a search engine targeting a Canadian market. As such, the search engine targeting the Indian market will be less robust than the search engine targeting the Canadian market. Thus, there is a need to increase the amount of training data available to train the ranking functions of search engines, especially for search engines targeted to specific markets.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating an example set of components involved in generating a ranking function;

FIG. 2 is a block diagram illustrating an example process of training a universal ranking function including feature normalization;

FIG. 3 illustrates an exemplary method for training a universal ranking function with two or more normalized training data sets;

FIG. 4 illustrates an exemplary method for determining values to be used in normalizing the distributions of feature scores of sets of training data;

FIG. 5 is a block diagram illustrating an example process of normalizing the feature scores of a selected set of documents to be ranked;

FIG. 6 illustrates an example method of adapting a training data set to conform to a universal training data set using feature adaptation;

FIGS. 7A-7B illustrate an example process of mapping a particular feature score of a particular feature in a set of adapting training data to a corresponding feature score of the particular feature in a set of universal training data;

FIG. 8 illustrates a graph of mappings between features scores of a particular feature in two sets of training data;

FIG. 9 is a block diagram illustrating an example process of adapting the feature scores of a selected set of documents to be ranked;

FIG. 10 illustrates an example of adapting training data for a selected market to align with the training data for a target market; and

FIG. 11 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention. Various aspects of the invention are described hereinafter in the following sections:

I. General Overview

II. MACHINE LEARNING SEARCH FUNCTIONS

III. UNIVERSAL FRAMEWORK

IV. FEATURE NORMALIZATION
A. Normalization Techniques
   1. LINEAR TRANSFORMATION
B. Normalizing Input Data

V. Feature Adaptation
A. Feature Mapping
B. Search and Similarity Functions
C. Optimization of Feature Mapping
D. Adapting Input Data
E. Targeted Feature Adaptation

VI. ALTERNATIVE IMPLEMENTATIONS

VII. HARDWARE OVERVIEW

### I. General Overview

To increase the amount of training data available to train a robust machine learning ranking function, data from two or more markets are normalized in such a manner as to optimize a an evaluation metric, e.g., the Discounted Cumulative Gain, or the click-through rate, of the ranking function trained on the various sets of normalized training data.

Furthermore, the feature scores of training data from one or more individual markets may be adapted to conform to the distributions of feature scores from a base market such that the training data from the one or more individual markets and the base market may be used to train a single, robust ranking function. Adaptation of feature scores in a particular training data set involves mapping feature scores of the particular training data set to feature scores of a second training data set to conform the distributions of the feature scores in the particular training data set to the distributions of the feature scores in the second training data set. In one embodiment of the invention, a subset of the feature scores in a particular training data set are mapped according to certain embodiments of this invention. Preferably, the mapped subset of feature scores are spaced evenly across the range of possible feature scores, and mappings for the balance of the feature scores in the particular training data set are estimated using linear interpolation based on the mapped feature scores.

In another aspect of the invention, before a ranking function trained on normalized or adapted training data assigns relevance scores to a set of documents with regard to a submitted query, the feature scores of the set of documents are normalized or adapted, as appropriate, according to the method of normalization or adaptation performed on the training data for the ranking function.

### II. Machine Learning Search Functions

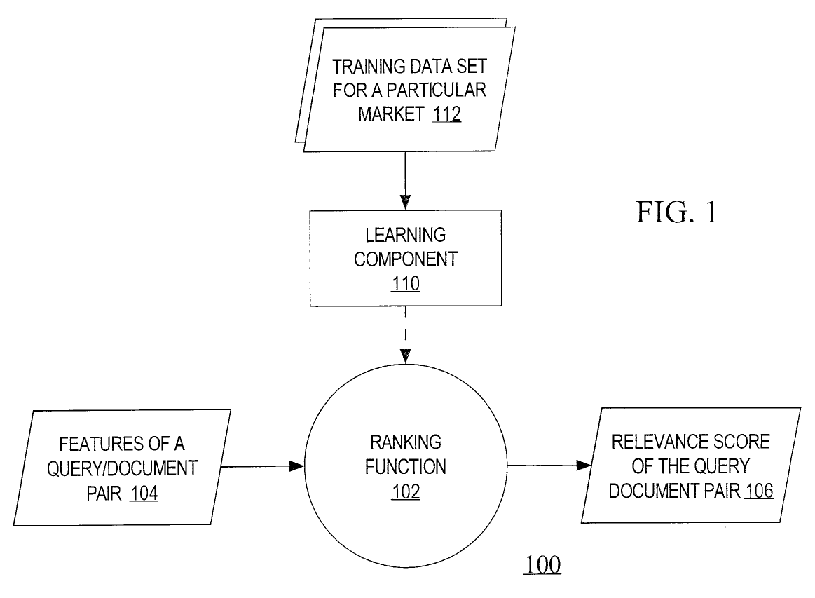

Machine learning techniques may be used to train a ranking function utilized by search engines to respond to user queries. FIG. 1 is a block diagram 100 illustrating an example of various components involved in generating a ranking function 102 which calculates relevance scores for query/document pairs that include a particular submitted query. Such relevance may be measured by any number of techniques well known in the art. Ranking function 102 accepts, as input, features 104 of a query/document pair. For example, features 104 of a particular query/document pair may include how many times the particular query has been previously received by the search engine, how many known documents include links to the particular document, or how well words in the particular query match words in the URL corresponding to the particular document, etc. Such examples of features of query/document pairs are non-limiting; any given query/document pair may include the example features, or may include an entirely different set of features.

Each feature of the features 104 of a query/document pair is associated with a score. Such scores may be generated by a process associated with a search engine, or may be gathered from another source. For example, a search engine may include a process for determining the “spamminess” of a particular document. In this context, spamminess is used to signify the quality of content found in the particular document, and may also take into account the quality of documents that are linked to the particular document, e.g., through links included in the particular document. In this example, the spamminess of a particular document may have a score ranging from 0 to 250. A score of 0 means that the particular document is of perfect quality, i.e., is “not spammy”, and a score of 250 means that the particular document has no redeeming qualities, i.e., is “super spammy”.

Based on the scores associated with features 104 of a query/document pair, ranking function 102 calculates a relevance score 106 for the query/document pair. Relevance score 106 may be a graded relevance score, for example, a number or other enumerated value, such as chosen from the set of [“Perfect”, “Excellent”, “Good”, “Fair”, and “Bad”]. The relevance score signifies the extent to which the document of the query/document pair is relevant to the query of the query/document pair. Graded relevance scores are not limited to these enumerated values within the embodiments of the invention. For example, possible graded relevance scores may include any number of possible grades, including four grades, three grades, or binary grades.

Ranking function 102 is produced using machine learning techniques. As such, ranking function 102 is trained to recognize qualities of particular query/document pairs that warrant a particular relevance score, based on training data. Ranking function 102 is generated by a learning component 110. If ranking function 102 is designed to target a particular market, then learning component 110 utilizes a training data set 112 for the particular market to generate ranking function 102. Such a training data set 112 may include information on documents that are pertinent to issues local to the target market, which is valuable information for a targeted search engine. While the example of FIG. 1 shows a training data set 112 that is targeted to a particular market, ranking function 102 may be trained on a training data set that is not targeted to a particular market.

As previously indicated, training data set 112 includes query/document pairs, and each query/document pair is associated with a set of feature scores. Each query/document pair included in training data set 112 is also associated with a relevance score assigned by a human or specialized automated process. Learning component 110 determines what combination of feature scores correlates with a given relevance score within training data set 112. Learning component 110 generates ranking function 102 such that the ranking function accurately predicts the human-annotated relevance score of each of the items in training data set 112 based on the set of feature scores associated with each item, respectively.

If the number and the quality of query/document pairs in training data set 112 are representative of the entire problem space, then ranking function 102 developed by learning component 110 is able to assign accurate relevance scores to query/document pairs not in training data set 112 based on the features of those pairs. An accurate relevance score for a query/document pair is a score that a human would likely give to the pair. However, if training data set 112 is not of a sufficient sample size, then the correlations that learning component 110 drew between particular combinations of feature scores and the appropriate relevance score will not be as accurate, and ranking function 102 will not be robust. In this situation, ranking function 102 undesirably assigns, to query/document pairs, relevance scores that a human would not assign.

### III. Universal Framework

Some markets do not have sufficient training data produced by the respective markets to train respective ranking functions to produce relevance scores accurately. Targeted search engines for such markets would benefit from additional training data made available through combining sets of training data produced by two or more markets and training a ranking function on the combined training data. Such a ranking function may be the basis for a universal framework for search engines targeting each of the two or more markets. Search engines based on such a universal framework can access and serve the common knowledge shared across several markets in a unified manner. A customization component can be built on top of search engines targeted to specific markets to add local-specific features, while maintaining the universality of the framework.

One way of combining training data for disparate markets is to simply use both sets of data to train a model without any manipulation of the data. However, feature scores for query/document pairs might not be assigned according to the same criteria in each market. For example, it may be the custom in producing training data for an Indian market that a query/document pair having a document of very high quality be associated with a spamminess score of 100. In contrast, it may be the custom in producing training data for a Canadian market that a similar query/document pair having a document of very high quality be associated with a spamminess score of 50. Thus, according to the customs of Canada, a document with a spamminess score of 100 would be of lesser quality information than a document with a spamminess score of 100 in the Indian training data set.

If training data sets with feature scores having different distributions, as illustrated above, are combined without any manipulation, then the resulting combined training data set will not be representative of the distribution of the feature scores for any of the training data sets from the respective markets. Thus, much of the information included in the training data combined in this manner is converted to noise, or is made more imprecise because of the combination. To prevent conversion of data to noise upon combination of data from disparate markets, the distributions of the features of the data may be made compatible through feature normalization or feature adaptation before the data is combined and utilized for training the universal ranking model.

### IV. Feature Normalization

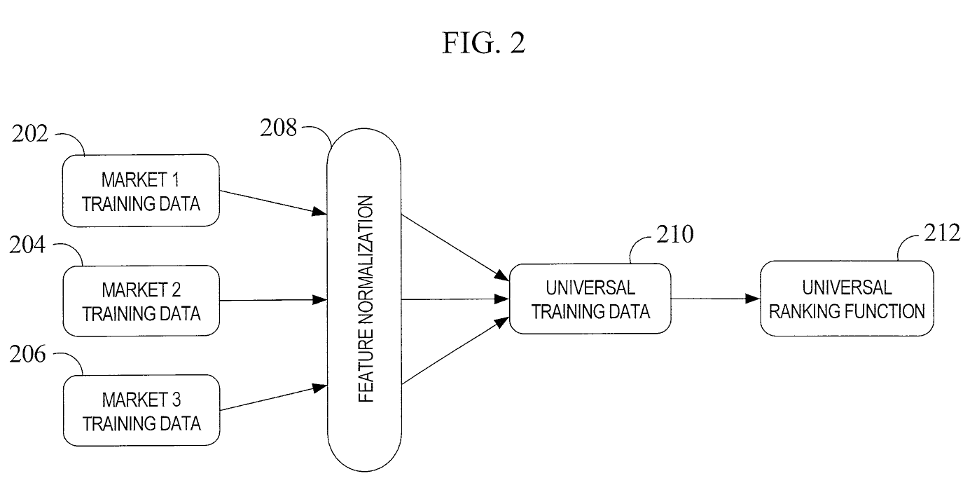

In one aspect of the invention, the distributions of feature scores of training data from two or more markets are normalized, such as to uniform or standard distributions, before using the combined sets of training data to train a ranking function for the universal framework mentioned above. For example, as illustrated by FIG. 2, training data set 202 from the Market 1, training data set 204 from Market 2, and training data set 206 from Market 3 are normalized using feature normalization 208 according to certain embodiments of this invention. Market 1, as well as Markets 2 and 3, may correspond to a national region, portions of national regions, or multiple national regions. The normalized training data sets 202, 204, and 206 are combined into universal training data 210. Universal ranking function 212 is trained using machine learning techniques and universal training data 210. While feature normalization is described herein with respect to a universal framework, the aspects of this invention may be practiced independently from such a universal framework.

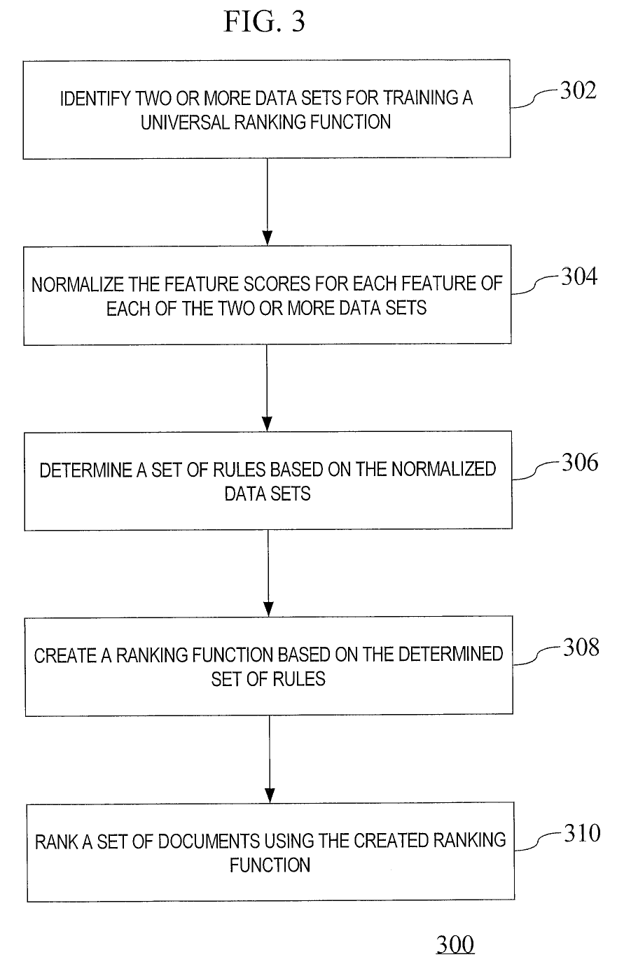

FIG. 3 illustrates an exemplary method for training a universal ranking function with two or more normalized training data sets. At step 302, two or more data sets are identified for training a universal ranking function. For example, training data set 202 from Market 1, training data set 204 from Market 2, and training data set 206 from Market 3 (FIG. 2) are identified.

At step 304, the feature scores for each feature of each of the two or more data sets are normalized. For example, the features scores of training data sets 202-206 are normalized using feature normalization 208, according to certain embodiments of the invention as described in further detail below. Normalizing the feature scores of a particular set of training data may include causing the distributions of the feature scores to conform to a uniform or Gaussian distribution for each feature of the training data, respectively. This normalization of feature scores enables the training data from multiple markets to be comparable across the multiple markets so that a feature score a particular feature has the same meaning across markets.

At step 306, a set of rules are determined based on the normalized data sets. For example, a machine learning model may be trained based on universal training data 210, which is the combination of normalized training data sets 202-206. Such a machine learning model may produce a set of rules learned based on universal training data 210.

At step 308, a ranking function is created based on the determined set of rules. For example, universal ranking function 212 is created based on rules learned by training a machine learning model on universal training data 210. Because universal ranking function 212 is based on data from multiple normalized training data sets 202-206, universal ranking function 212 is more accurate in assigning representativeness scores to query/document pairs that are not included in the training data than a ranking function trained on a lesser amount of training data, i.e., trained on only one of training data sets 202-206.

The ranking function created at step 308, e.g., universal ranking function 212, can be used to develop search engines targeted to various markets. Accordingly, at step 310, a set of documents are ranked using the created ranking function. For example, universal ranking function 212 may be included in search engines targeted to the markets associated with each of the identified data sets, Markets 1, 2, and 3. Such targeted search engines use the universal ranking function to rank documents in response to search queries. For example, a search engine for a first market, a search engine for a second market, and a search engine for a third market may all be based on universal ranking function 212 trained using the normalized training data sets 202-206 from all of these markets. Additionally, universal ranking function 212 may be included in search engines targeted to markets that did not contribute training data to universal training data 210.

### A. Normalization Techniques

Several techniques may be used to normalize the feature scores of a particular set of training data. For example, statistical normalization may be used to normalize the feature scores of a particular data set through scaling the feature scores for each feature in the data to have a mean of 0 and a standard deviation of 1, so that 68% of the data lies in the range (−1, 1). This normalization scheme may be represented as illustrated in Eq. 1:

xᵢ=(xᵢ−mean)/sd Eq. 1

where xᵢ represents a feature score for feature x of the ith query/document pair of the particular data set, mean represents the mean of all of the feature scores of the feature x prior to application of statistical normalization, and sd represents the standard deviation of the feature scores of feature x prior to application of statistical normalization. Such a normalization scheme ensures that a given distribution of feature scores is transformed into a Gaussian distribution.

A further example of a technique that may be used to normalize the feature scores of a particular set of training data is linear scaling, in which all of the scores of a particular feature of the particular data set are scaled to the range (0, 1) using the maximum and minimum values of each respective feature, as illustrated in Eq. 2

xᵢ=(xᵢ−min)/(max−min) Eq. 2

where xᵢ represents a feature score for feature x of the ith query/document pair of the particular data set, min represents the lowest feature score of feature x, and max represents the highest feature score of feature x. This normalization scheme ensures that the feature scores for all of the features of all of the normalized data sets will have the same range, i.e. (0.1). This scheme also ensures that the normalized data sets follow uniform distributions, i.e., all intervals in the range are equally probable.

A third example of a technique that may be used to normalize the feature scores of a particular set of training data is rank normalization, in which the feature scores of a particular feature are first sorted and the ranks of the feature scores are used to normalize the scores, as illustrated in Eq. 3:

xᵢ=(rank(xᵢ)−1)/(n−1) Eq. 3

where xᵢ represents a feature score for feature x of the ith query/document pair of the particular data set, rank(xᵢ) represents the rank of the feature score xᵢ when the feature scores for feature x are ordered, and n represents the total number of query/document pairs in the particular set of training data. This normalization scheme ensures that all feature values of the set of training data are in the range [0,1]. When two query/document pairs of the training data set have the same feature score, then they are assigned the average rank for that feature score.

### 1. Linear Transformation

Yet another example of a technique that may be used to normalize the feature scores of a particular set of training data is linear transformation. This technique involves normalizing feature scores for training data from multiple markets based on optimizing the result of an evaluation metric for measuring the quality of the ranking function resulting from training a machine learning model on the training data for these multiple markets. The result of an evaluation metric is referred to as an evaluation score for convenience. For example, a well-known relevance evaluation metric for a ranking function is Discounted Cumulative Gain (DCG). If the DCG score of a particular ranking function is high, then the ranking function produces very relevant results in response to user queries. Another example of an evaluation metric that measures the user satisfaction of a ranking function is the average click-through rate corresponding to the query/document pairs in the training data set for the ranking function. The click-through rate for a query/document pair can be calculated as the ratio of the number of clicks received on a document for the given query to the total number of times the document is shown for the query. Other evaluation metrics may also be used within the embodiments of the invention, such as evaluating the similarity between feature distributions across markets, etc. In one embodiment of the invention, feature scores of multiple data sets, i.e., from multiple markets, are normalized based on optimizing an evaluation score of the ranking function produced by training a machine learning model on the normalized training data.

Linear transformation normalizes feature scores for a particular feature from a particular data set, i.e., from a particular market, using the following Eq. 4:

xᵢ′=alphaᵢ*xᵢ+betaᵢ Eq. 4

where xᵢ represents a pre-normalization feature score of the ith feature in a particular data set, xᵢ′ represents a post-normalization feature score of the ith feature in the particular data set, and alphaᵢ and betaᵢ are parameters that are learned in order to optimize an evaluation score of a ranking function trained at least on the post-normalization feature score xᵢ′.

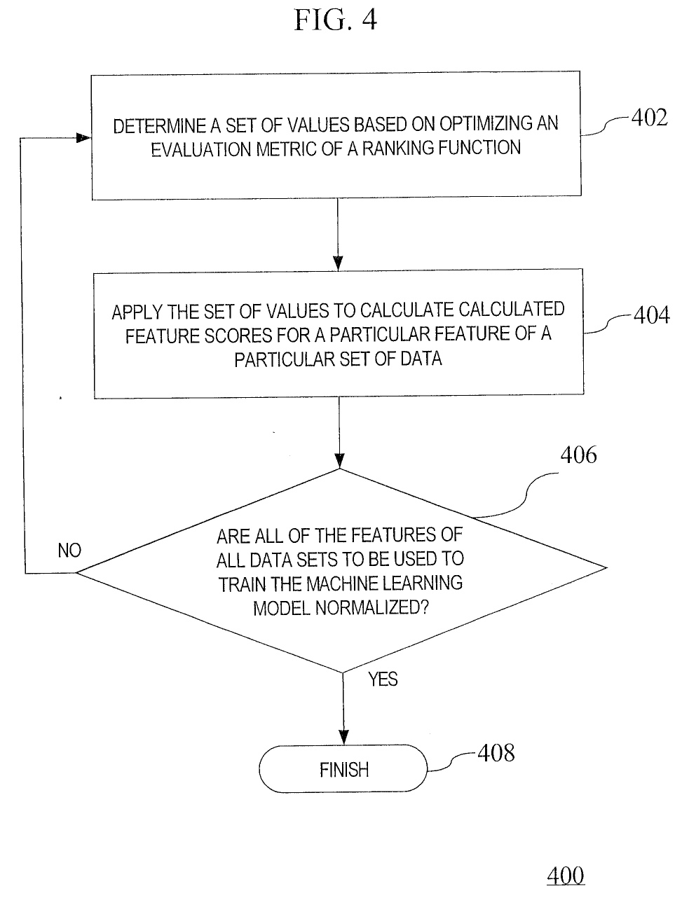

FIG. 4 illustrates an exemplary method for determining an alpha and a beta from Eq. 4 for a particular feature of a particular data set, and transforming the feature scores of the particular feature accordingly. At step 402, a set of values is determined based on optimizing an evaluation score of a ranking function. For example, in one embodiment of the invention, alpha and beta are learned for a particular feature, i, in a particular data set by optimizing the result of an evaluation metric such as the DCG of the ranking function trained using the data set. A search algorithm such as downhill simplex method may be implemented to find an alpha and a beta for the particular feature that optimizes the evaluation score. Downhill simplex method (also known as Amoeba) is described in Nelder J. A., Mead R., Downhill Simplex, In Computer Journal, 7, 308, 1965, the disclosure of which is incorporated by reference in its entirety. Amoeba is a commonly used nonlinear optimization algorithm for minimizing an objective function in a many-dimensional space. While this aspect of the invention is described with respect to Amoeba, other methods of finding the optimal alpha and beta for each feature in a particular data set may be used, e.g., exhaustive search, greedy search, etc.

To determine values of alpha and beta for a particular feature, i, that optimize the evaluation score using Amoeba, a starting point for alpha and beta is first determined. For example, the starting point for alpha may be 1, and the starting point for beta may be 0. These example starting points are based on the assumption that the initial value of the particular feature score, xᵢ, is a good approximation of the value of the feature score that optimizes the evaluation score. Given this initial starting point, Amoeba returns an alpha and a beta that produce an optimum evaluation score when applied to the scores of the particular feature. In one embodiment of the invention, one alpha and one beta are found for each feature of each data set to be normalized because the distributions of the feature scores of a particular feature of the data sets may vary across the training data sets from the various markets.

For example, if the applicable evaluation metric is DCG, then Amoeba may determine an optimal alpha and beta by calculating the DCG for a ranking function based on the feature scores transformed by the alpha and beta according to Eq. 4. As a further example, if the applicable evaluation metric is click-through rate, then Amoeba may determine an optimal alpha and beta by choosing the alpha and beta that yield the highest historical click-through rate for a ranking function based on the feature scores transformed by the alpha and beta according to Eq. 4. The historical click-through rate may be determined given the historical click-through rate for each query/document pair in the training data set.

At step 404, the set of values are used to calculate calculated feature scores for a particular feature of a particular set of data. For example, once the optimal alpha and beta are found for the particular feature, i, of the particular data set, the feature scores of feature, i, are normalized using the optimal alpha and beta, as illustrated in Eq. 4. In one embodiment of the invention, the normalized values of each feature of each set of training data are used in determining the alpha and beta for features that have yet to be normalized. For example, if the feature scores of a first feature of a particular data set have been normalized and the feature scores of a second feature of the particular data set have not yet been normalized, then the determination of an optimal alpha and beta will include the normalized feature scores of the first feature. Alternatively, alpha and beta are determined using pre-normalization feature scores of all features that will be used to train the universal ranking function.

At step 406, it is determined whether all of the features of all data sets that are to be used to train the machine learning model are normalized. If so, then exemplary method 400 is finished. If not, then another set of values are determined based on optimizing an accuracy score of a ranking function at step 402. After exemplary method 400 is finished at step 408, all features of all data sets used to produce the universal ranking function have been normalized according to Eq. 4. After such normalization, feature scores for a given feature will be comparable across training data sets gathered in individual markets because each feature in all training data sets have the same feature distributions. The consistency of feature distributions across the training data sets allows a ranking function trained with the training data sets to behave robustly across the various markets. Using a previous example, information in a document with a spamminess score of 100 from a Canadian training data set would be of a comparable quality to information in a document with a spamminess score of 100 from an Indian training data set.

After all of the data is normalized, all of the sets of normalized data are used to train the universal ranking function to create a universal framework for search engines targeted to each of the markets. Because the data in the multiple training data sets are normalized, the values therein are comparable. Further modifications may be made to the search engines targeted to a particular market to customize the search engine to the market. For example, a search engine targeted to a Canadian market could consider whether documents contain information specifically relevant to Canada. Such modifications are discussed in more detail below.

### B. Normalizing Input Data

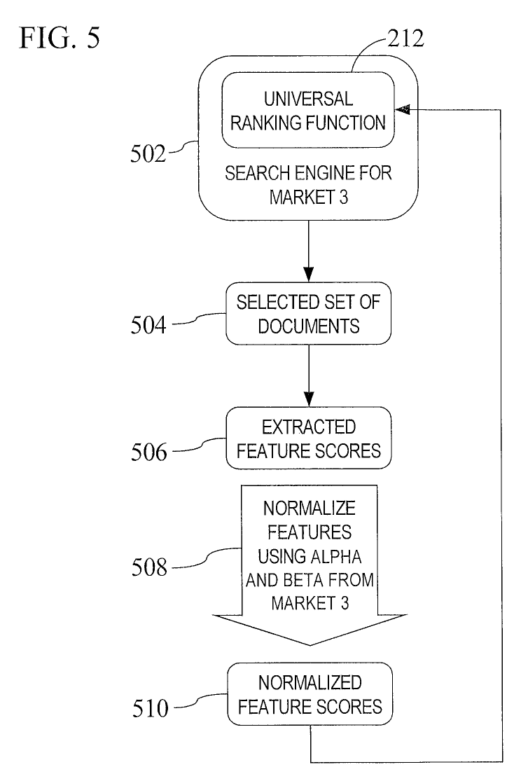

In another embodiment of the invention, data being ranked by a targeted search engine using universal ranking function 212 (FIG. 2) is also normalized using the alphas and betas found for the target market. FIG. 5 illustrates a search engine 502 for Market 3 that is targeted to Market 3, which implements universal ranking function 212 of FIG. 2. Search engines built on a universal ranking function, such as search engine 502, may be targeted to a particular market using many different methods. For example, such a targeted search engine may be based on a machine learning ranking function that has been trained on training data developed for a particular market, or a targeted search engine may be customized to provide targeted results. Any combination of the above-mentioned techniques or other techniques may be used to customize a search engine for a particular market.

When a typical search engine receives a query, the search engine generally selects a set of documents to be ranked from the universe of documents available to the search engine. Such selection may be based on all manner of criteria, such as the inclusion of a word from the received query in documents selected for ranking, etc. Feature scores associated with each document to be ranked are extracted or calculated, as appropriate, and are input to the ranking function of the typical search engine. The ranking function generally bases the relevance score to be assigned to a particular document on the feature scores of the particular document. Once each document in the set has received a relevance score, the documents are generally sorted based on assigned relevance scores and are generally presented to the entity that submitted the query.

However, search engine 502 is based on universal ranking function 212, which is trained using normalized feature scores. Thus, the training data for universal ranking function 212 likely has different feature score distributions than the feature scores of the documents to be ranked. This difference in feature score distributions may introduce inaccuracies into the document ranking process.

To mitigate such inaccuracies, one embodiment of the invention normalizes the feature scores of documents selected to be ranked prior to submitting the feature scores to the ranking function. For example, search engine 502 selects a set of documents 504 to be ranked from the universe of documents available to search engine 502. The feature scores 506 of the set of documents 504 are extracted. Then, feature scores 506 are normalized using the same alpha and beta 508 identified when the training data set 202 for Market 3 (FIG. 2) was normalized prior to training universal ranking function 212, according to certain embodiments of the invention. The normalized feature scores 510 are then provided to universal ranking function 212 for ranking. Thus, the set of documents are ranked based on the documents' normalized feature scores.

### V. Feature Adaptation

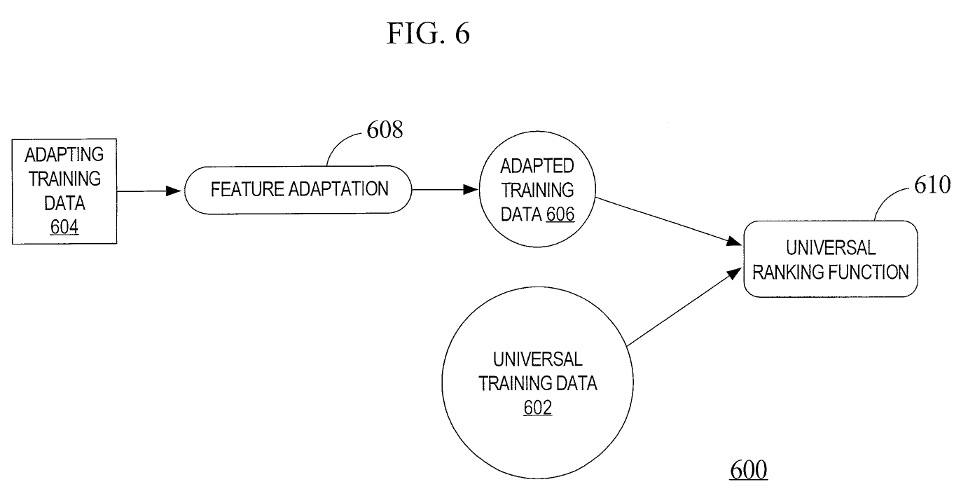

Another method of developing training data for a universal ranking function is to adapt the feature scores of sets of training data to conform to the feature scores of a body of training data developed for the universal training function, called “universal training data” for convenience. FIG. 6 illustrates an example 600 of adapting a set of “adapting training data”, so called for convenience, to conform to a universal training data set. In example 600, universal training data 602 is represented by a circle and adapting training data 604 is represented by a square to denote the fact that the distributions of feature scores in adapting training data 604 do not conform to the distributions of feature scores in universal training data 602. Adapted training data 606 is represented by a circle to denote that the distributions of feature scores of adapted training data 606 conform to the distributions of feature scores of universal training data 602.

Universal training data 602 may be training data developed by a particular market with a large amount of resources, such as the United States. Alternatively, universal training data 602 may be the result of feature normalization, according to certain embodiments of this invention. Alternatively, universal training data 602 may be the result of previous feature adaptation, according to certain embodiments of this invention, or may be developed in any other way.

According to certain embodiments of the invention, the adaptation of adapting training data 604 to universal training data 602 includes transforming the distributions of feature scores in adapting training data 604 to be similar to the distributions of feature scores in universal training data 602 using feature adaptation 608. The resulting adapted training data 606 may be used in conjunction with universal training data 602 to train a universal ranking function 610 that is more robust than a ranking function that is trained on either training data set alone.

### A. Feature Mapping

To adapt a set of training data developed for a particular market, e.g., adapting training data 604, to conform to a set of universal training data 602, each feature score for each feature in adapting training data 604 is mapped to a particular feature score for the corresponding feature in universal training data 602. These mappings are based on the distributions of relevancy scores for each particular feature score, as described in more detail hereafter. The feature scores in adapting training data 604 are then replaced with the corresponding feature scores from the universal training data 602 to produce adapted training data 606. As such, adapted training data 606 is comparable to universal training data 602, and may be included with the universal training data to train a universal ranking function effectively.

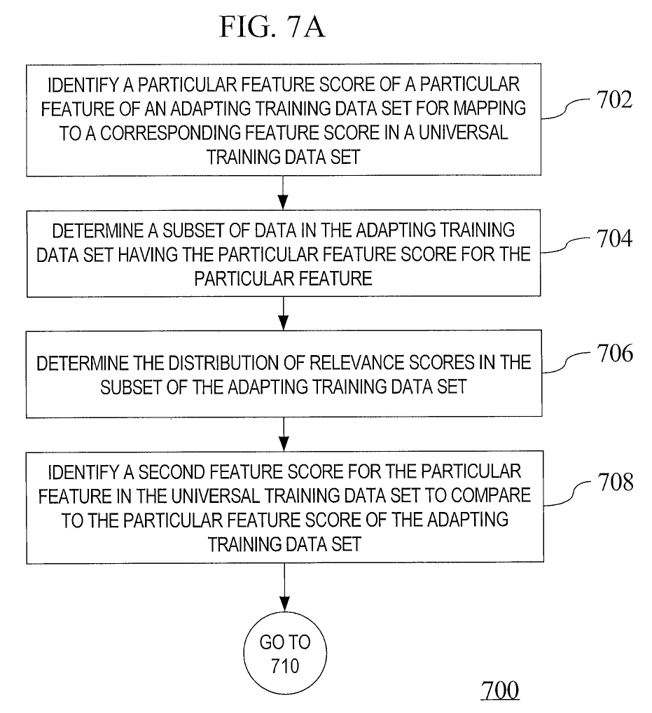

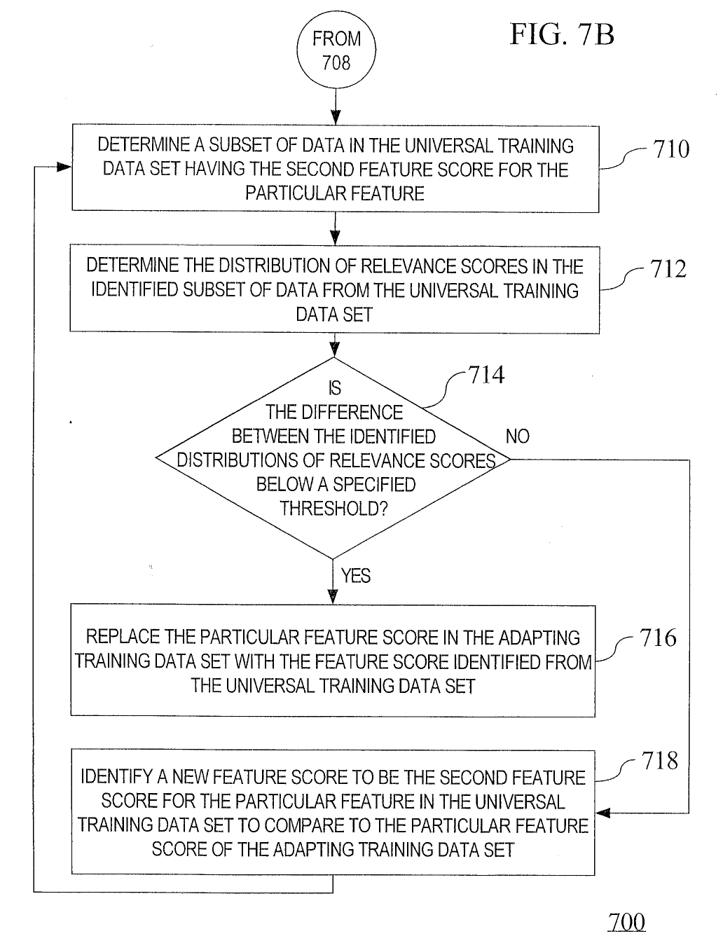

FIGS. 7A-7B illustrate an example method 700 of mapping a particular feature score of a particular feature in a set of adapting training data to a corresponding feature score of the particular feature in a set of universal training data. At step 702, a particular feature score of a particular feature of the adapting training data set is identified for mapping to a corresponding feature score in a universal training data set. For example, a spamminess score of 200 is identified in adapting training data 604 of FIG. 6 for mapping to a spamminess score in universal training data 602. At step 704, a subset of data of the adapting training data set is determined to have the particular feature score for the particular feature. For example, it is determined that a particular subset of 100 query/document pairs in adapting training data 604 is associated with a spamminess score of 200.

At step 706, the distribution of relevance scores in the subset of the adapting training data set is determined. By definition, each data item, i.e., each query/document pair, in a training data set is associated with a relevance score by a human. In one embodiment of the invention, a query/document pair may be associated with one of five graded relevance scores: “perfect”, “excellent”, “good”, “fair”, and “bad”. For example, out of the 100 query/document pairs in adapting training data 604 that have a spamminess score of 200, 80 have a “bad” relevance score, 20 have a “fair” relevance score, and zero have “good”, “excellent”, or “perfect” relevance scores. For convenience of explanation, this distribution is denoted as relevancy vector [0, 0, 0, 0.2, 0.8], where the numbers in the vector represent percentages of data items having a spamminess score of 200 that are associated with a relevance score of “perfect”, “excellent”, “good”, “fair”, and “bad”, respectively. The fact that relevancy vector [0, 0, 0, 0.2, 0.8] is associated with the spamminess score of 200 indicates that if a document of a particular query/document pair is associated with a 200 spamminess score in adapting training data 604, then the query/document pair is almost never a good match, and therefore should receive a relevance score of “bad” 80% of the time.

In one embodiment of the invention, the distribution of relevance scores for a particular feature score includes the relevance scores of only those query/document pairs having the particular feature score. In another embodiment of the invention, the distribution of relevance scores for a particular feature score includes the relevance scores of all query/document pairs with a feature score that is greater than or equal to the particular feature score.

At step 708, a second feature score for the particular feature is identified in the universal training data set to compare to the particular feature score of the adapting training data set. For example, a spamminess score of 200 may be identified in universal training data 602 to compare to the spamminess score of 200 in adapting training data 604. Choosing the same score to compare in adapting training data 604 and the universal training data 602 is a good starting point for a search for an appropriate mapping. However, any criteria may be used to choose the feature score for the comparison starting point.

At step 710, a subset of data in the universal training data set is determined that has the identified second feature score, and at step 712, the identified subset of data from the universal training data set is scrutinized to determine the relevance score distribution. For example, the subset of query/document pairs in universal training data 602 of FIG. 6 that are associated with a spamminess score of 200 have a relevancy vector of [0, 0, 0.2, 0.2, 0.6]. This indicates that documents in universal training data 602 with a spamminess score of 200 are slightly more likely to be relevant to a query than documents in adapting training data 604 with a spamminess score of 200. Therefore, it is shown that a spamminess score of 200 in adapting training data 604 is not equivalent to a spamminess score of 200 in universal training data 602.

At step 714, it is determined whether the difference between the distribution of relevance scores for the subset of adapting training data and the distribution of relevance scores for the subset of universal training data is below a specified threshold. For example, the relevancy vector for the identified subset of adapting training data 604 is [0, 0, 0, 0.2, 0.8] and the relevancy vector for the identified subset of universal training data 602 is [0, 0, 0.2, 0.2, 0.6]. One measure of the difference between these vectors is the magnitude of the difference between the percentages of each possible relevance score of the vectors. Under this measure, the difference is 20% for “good” relevance scores and 20% for “bad” relevance scores, with no difference for the other relevance scores. If the specified threshold for this example is no less than 2% difference for each of the possible relevance scores, then the difference between the identified distributions is not below the specified threshold. Other methods of determining the difference between relevancy vectors may be used within the embodiments of this invention, some examples of which are discussed in further detail below. Also, any manner of threshold may be used as the specified threshold for the embodiments of the invention.

If the difference between the identified distributions of relevance scores is not below a specified threshold, then, at step 718, a new feature score is identified to be the second feature score for the particular feature in the universal training data set to compare to the particular feature score of the adapting training data set. In the previous example, a spamminess score of 200 in universal training data 602 was shown to have a more favorable relevance score distribution than a spamminess score of 200 in adapting training data 604. Therefore, it may be postulated that a higher spamminess score in universal training data 602 may be a better mapping for the spamminess score of 200 in adapting training data 604. Thus, a spamminess score of 220 is identified to be the new feature score from universal training data 602 to compare to the spamminess score of 200 from adapting training data 604. Other methods of searching for an appropriate mapping between feature scores of training data sets may be used within the embodiments of this invention, some examples of which are discussed in further detail below. Furthermore, a search may be made in the adapting training data set to find values that map to values in the universal training data within the embodiments of the invention.

At step 710, a subset of data in the universal training data set having the new feature score for the particular feature is determined, and at step 712, the distribution of relevance scores in the identified subset of data from the universal training data set is determined. Continuing with the previous example, the subset of data in universal training data 602 corresponding to a spamminess score of 220 is determined to have a relevancy vector of [0, 0, 0, 0.2, 0.8]. At step 714, it is determined that the difference—0% for each possible relevance score—is less than the example specified threshold of 2% for each possible relevance score.

Therefore, at step 716, the particular feature score in the adapting training data set is replaced with the identified feature score from the universal training data set. Thus, in the previous example, spamminess scores of 200 associated with query/document pairs in adapting training data 604 are replaced with spamminess scores of 220. When all of the feature scores of all of the features associated with adapting training data 604 are replaced with corresponding values from universal training data 602, then adapting training data 604 is transformed to adapted training data 606, which conforms to the feature score distributions of universal training data 602.

In one embodiment of the invention, all of the mappings between feature scores in an adapting training data set and a universal training data set are determined before replacing the feature scores in the adapting training data set with scores from the universal training data set. In another embodiment of the invention, a mapping is found for every possible feature score of every feature of an adapting training data set. However, a universal training data set might not include all of the features in the adapting training data set, or the universal ranking function to be produced using the training data might not take into account each of the features in the adapting training data set. Thus, in yet another embodiment of the invention, the feature scores of a subset of the features that are found in an adapting training data set are mapped to appropriate feature scores in a universal training data set.

### B. Search and Similarity Functions

To find appropriate mappings between feature scores of a particular feature in two sets of training data, multiple search functions may be implemented within the embodiments of the invention. In one embodiment of the invention, a mapping is identified by optimizing the similarity of the relevance score distributions associated with the respective feature scores, as illustrated by Eq. 5:

f_target′=argmax_{—}f′Sim(C_target(f_target), C_universal(f′)) Eq. 5

where f_target is the feature score for a particular feature, f, of the adapting training data set to be mapped; f′ is the feature score for the particular feature, f, of the universal training data set that is being evaluated as a possible candidate for mapping to f_target; C_target(f_target) denotes the probability vector of the distribution of relevance scores associated with f_target in the adapting training data set; C_universal(f′) denotes the probability vector of the distribution of relevance scores associated with f′ in the universal training data set; Sim denotes a similarity function, described in more detail below; and f_target′ denotes the feature score that maps to f_target. Thus, Eq. 5 represents finding the best feature score f_target′ to map to f_target based on maximizing the similarity between the probability vectors of the distributions of relevance scores associated with f_target and f_target′.

The similarity function, denoted by Sim in Eq. 5, may be any function that computes the similarity (or difference) between probability distributions. For example, Kullback-Liebler Divergence, cosine similarity, Euclidean distance, root means square, etc., may be implemented as the similarity function, Sim, of Eq. 5.

Furthermore, search functions to find the f′ that maximizes the similarity function of Eq. 5 may be implemented as any manner of search function, such as Amoeba (as discussed above), exhaustive search, greedy search, etc. As such, any search function may be used that can search the space of relevance score probability distributions to determine the feature score that maximizes the similarity between the probability distributions of the relevance scores associated with the feature scores. Thus, the set of documents are ranked based on the documents' adapted feature scores.

### C. Optimization of Feature Mapping

Finding mappings for every possible feature score for every feature of an adapting training data set may be prohibitive. Therefore, in one embodiment of the invention, only a subset of the feature scores for a particular feature of an adapting training data set are mapped to feature scores in a universal training data set. The feature scores for the particular feature in the adapting training data set that are not mapped to feature scores in the universal training data set are estimated using interpolation. In one embodiment of the invention, linear interpolation is used to estimate these unmapped feature scores.

Any method may be used to chose particular feature scores to be mapped from the entire range of possible feature scores according to certain embodiments of the invention. For example, if spamminess scores in adapting training data 604 range from 0 to 250, then multiples of 25 may be chosen for explicit mapping. Thus, in this example, spamminess scores of 0, 25, 75, 100, 125, . . . , 225, and 250 in adapting training data 604 are mapped to feature scores in universal training data 602, for example, using example method 700 illustrated by FIGS. 7A-7B.

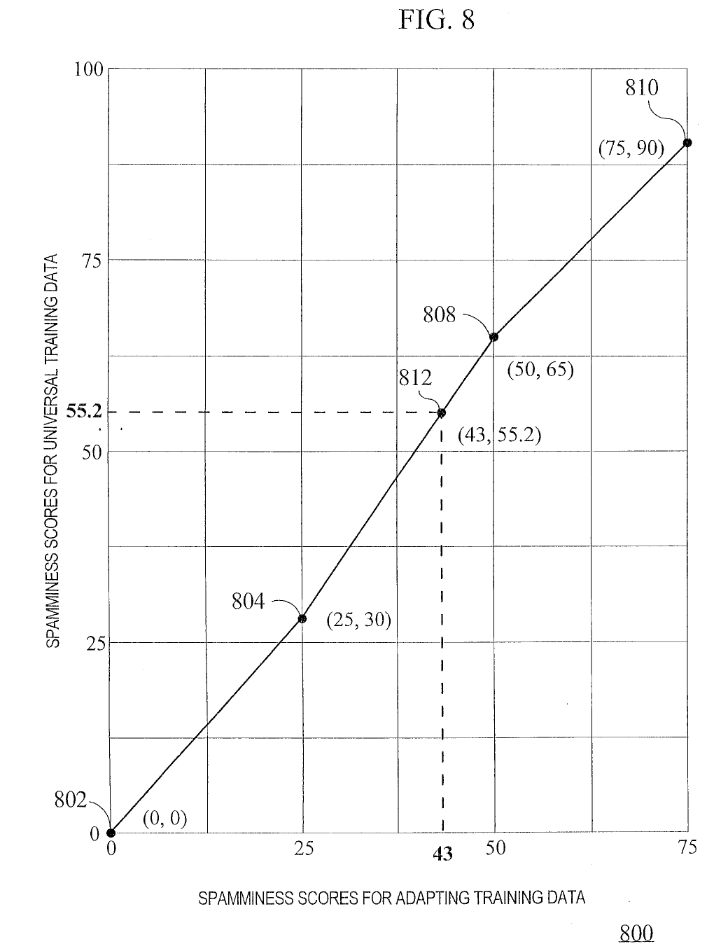

Spamminess scores that are not mapped according to certain embodiments of this invention may be estimated using linear interpolation. FIG. 8 illustrates a graph 800 of mappings for spamminess scores according to certain embodiments of this invention. In the example of FIG. 8 at mapping 802, a spamminess score of 0 in an adapting training data set has been mapped to a spamminess score of 0 in a universal training data set. For convenience, mapping 802 is denoted (0, 0) with the spamminess score for the adapting training data set represented by the former number and the corresponding spamminess score for the universal training data set represented by the latter number. The same convention is used in graph 800 to represent mapping 804 as (25, 30), mapping 808 as (50, 65), and mapping 810 as (75, 90). Graph 800 represents only an example portion of mappings for spamminess scores of an adapting training data set.

In one embodiment of the invention, linear interpolation is used to estimate mappings for spamminess scores that are not mapped according to certain embodiments of this invention. Linear interpolation is a simple form of interpolation where, if the mapping of a particular spamminess score is unknown, but mappings of spamminess scores that are greater and less than the particular spamminess score are known, then the particular spamminess score is estimated to be an appropriate point along a straight line drawn between the closest known mappings.

For example, a mapping for the spamminess score of 43 in the adapting training data set of FIG. 8 has not been determined according to certain embodiments of this invention. However, a mapping for the spamminess score of 25 in the adapting training data set has been calculated, i.e., at mapping 804, and a mapping for the spamminess score of 50 in the adapting training data set has been calculated, i.e., at mapping 808. The line between mapping 804 at (25, 30) and mapping 808 at (50, 65) is defined according to Eq. 6:

y=7/5x−5 Eq. 6

Eq. 6 may be found using standard methods of determining the equation of a line defined by two points, such as the slope-intercept method, or the point-slope method, etc.

The point on the line defined by Eq. 6 corresponding to a spamminess score of 43 in the adapting training data set may be found by interpreting 43 to be the x value and running the equation to determine the y value. The resulting mapping for the spamminess score of 43 in the adapting training data set is (43, 55.2) as indicated by mapping 812. Thus, every feature score for every feature of a set of adapting training data may be mapped to feature scores of corresponding features of a universal training data set without comparing relevancy vectors for each possible feature score.

### D. Adapting Input Data

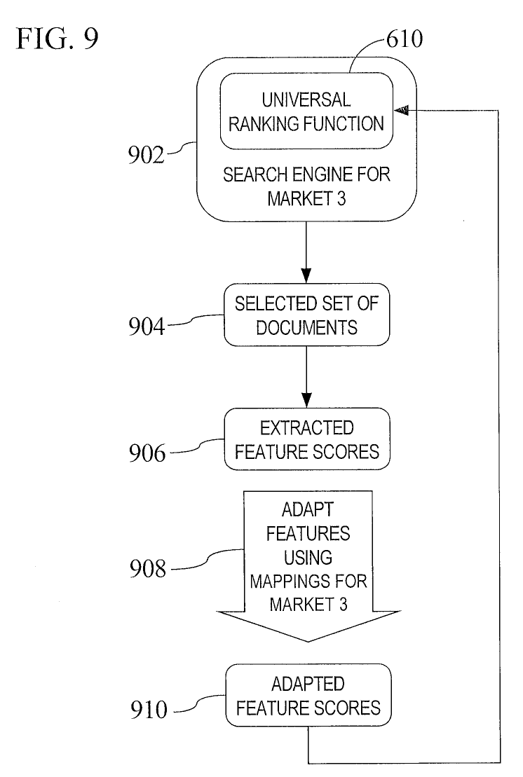

In another embodiment of the invention, the feature scores of data being ranked by a targeted search engine using universal ranking function 610 (FIG. 6) are also adapted using the mappings found for the target market. For example, search engine 902 for Market 3 of FIG. 9 illustrates a search engine implementing universal ranking function 610 that is targeted to a Market 3. If adapting training data 604 is training data developed for Market 3, then the mappings found for adapting training data 604 may be used to adapt the feature scores of documents being ranked by search engine 902.

As indicated with respect to feature normalization, the training data for universal ranking function 610 that has been manipulated using feature adaption will likely not have the same distributions of feature scores as the documents that search engine 902 ranks and presents as search results. To mitigate inaccuracies introduced by such a potential difference in feature score distributions, one embodiment of the invention adapts the feature scores of documents selected to be ranked prior to submitting the feature scores to the ranking function. For example, search engine 902 selects a set of documents 904 to be ranked from the universe of documents available to search engine 902. Feature scores 906 of set of documents 904 are extracted. Then, feature scores 906 are adapted using mappings 908 identified with respect to adapting training data 604, assuming adapting training data 604 was developed for a Market 3, according to certain embodiments of the invention. Mappings used to adapt feature scores 906 are preferably associated with the target market of selected set of documents 904. Adapted feature scores 910 are then provided to universal ranking function 610 for ranking.

In this embodiment of the invention, universal ranking function 610 more accurately assigns relevance scores to query/document pairs not included in the training data for universal ranking function 610 because adapted feature scores 910 used to rank selected set of documents 904 are comparable to those of universal training data 602.

### E. Targeted Feature Adaptation

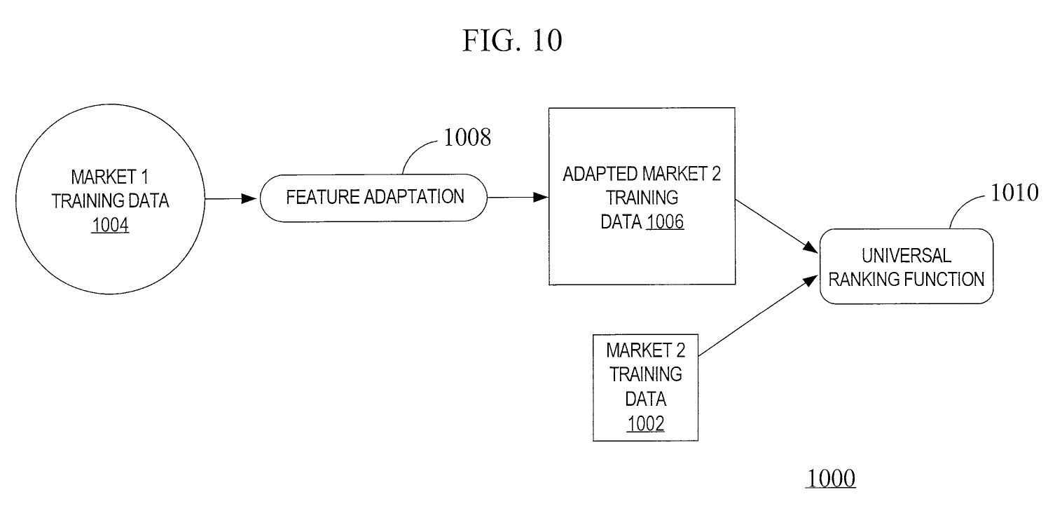

In another embodiment of the invention, training data developed for a particular target market is augmented with training data developed for a different market using feature adaptation, according to certain embodiments of this invention. As such, the distribution of feature scores for the features in the training data for the different market are aligned with the distributions of feature scores in the training data for the target market. FIG. 10 illustrates an example 1000 of adapting training data for a selected market to align with the training data for a target market. In example 1000 of FIG. 10, Market 2 is selected as a target market because the amount of training data 1002 developed for Market 2 is very small. The amount of training data 1004 developed for Market 1 is much larger than the amount of training data 1002 developed for Market 2. Such a difference in the amount of training data may be caused by a lack of resources or may be the result of varying amounts of time that have been dedicated to the development of the respective sets of training data.

In example 1000, it would be useful to leverage Market 1 training data 1004 in conjunction with Market 2 training data 1002 to train a ranking function targeted to Market 2 in order to produce a more robust ranking function than the function that would be produced using only Market 2 training data 1002. However, as previously discussed, training data developed in disparate markets may have different distributions of feature scores. Thus, to leverage the large amount of training data 1004 developed for Market 1 in a search engine targeted to Market 2, the distributions of feature scores of Market 1 training data 1004 are adapted to conform to the distributions of feature scores of training data 1002, resulting in adapted Market 2 training data 1006, according to certain embodiments of the invention. Because of the adaptation, adapted Market 2 training data 1006 resembles Market 2 training data 1002 with respect to distribution of feature scores. Thus, a search engine targeted to Market 2 may be trained on both Market 2 training data 1002 and adapted Market 2 training data 1006, which produces a more robust search engine than a search engine trained solely on Market 2 training data 1002.

### VI. Alternative Implementations

Embodiments of this invention are described in the context of training search engines. However, not all embodiments are not limited to this context. For example, a large amount of training data may exist to train a machine learning model to recognize human faces, and a small amount of data may exist to train a machine learning model to recognize animal faces. The small amount of training data for animal faces may result in a poor animal face recognition mechanism. Therefore, the distributions of feature scores in training data on human faces may be adapted, according to certain embodiments of the invention, to conform to the distributions of feature scores in the training data on animal faces. Both the adapted training data on human faces and the training data on animal faces may then be used to train a more robust machine learning model to recognize animal faces.

### VII. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

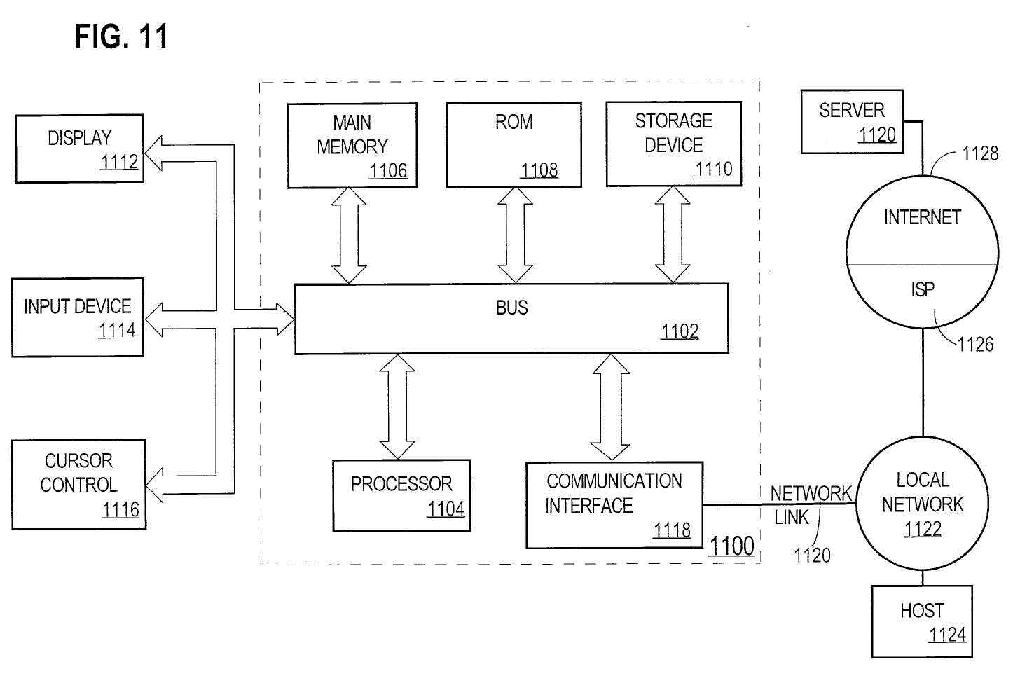

For example, FIG. 11 is a block diagram that illustrates a computer system 1100 upon which an embodiment of the invention may be implemented. Computer system 1100 includes a bus 1102 or other communication mechanism for communicating information, and a hardware processor 1104 coupled with bus 1102 for processing information. Hardware processor 1104 may be, for example, a general purpose microprocessor.

Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, such as a magnetic disk or optical disk, is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 1110. Volatile media includes dynamic memory, such as main memory 1106. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-executed method comprising:
determining a first data item from a first set of data, wherein the first data item includes a first original feature score for a particular feature;
calculating a first calculated feature score for the particular feature of the first data item based at least in part on a first set of values and the first original feature score;
determining a first evaluation score based at least in part on the first calculated feature score;
wherein the first set of values are selected based at least in part on optimizing the first evaluation score; and
wherein the method is performed by one or more computing devices.

2. The computer-executed method of claim 1, further comprising:
determining a set of rules based at least in part on the first calculated feature score;
creating a ranking function based at least in part on the set of rules;
ranking, based at least in part on the ranking function, one or more data items; and
wherein determining the first evaluation score further comprises basing the first evaluation score at least in part on the set of rules.

3. The computer-executed method of claim 2, further comprising:
determining a second data item from a second set of data, wherein the second data item includes a second original feature score for the particular feature;
calculating a second calculated feature score for the particular feature of the second data item based at least in part on a second set of values and the second original feature score; and
determining a second evaluation score based at least in part on the second calculated feature score;
wherein the second set of values are selected based at least in part on optimizing the second evaluation score.

4. The computer-executed method of claim 3,
wherein the first original feature score is measured according to a first scale;
wherein the second original feature score is measured according to a second scale; and
wherein the first scale is different than the second scale.

5. The computer-executed method of claim 2,
wherein the one or more data items correspond to data items in the first set of data;
wherein each data item of the one or more data items comprises a feature score for the particular feature; and
wherein the step of ranking the one or more data items further comprises:
calculating a calculated feature score for the particular feature of each data item of the one or more data items based, at least in part, on the first set of values to produce a set of one or more calculated feature scores,
providing the set of one or more calculated feature scores to the ranking function, and
ranking, by the ranking function, the one or more data items, based at least in part on the set of one or more calculated feature scores.

6. The computer-executed method of claim 3,
wherein the first set of data originates from a first market and the second set of data originates from a second market;
wherein a first data item of the one or more data items originates from the first market;
wherein a second data item of the one or more data items originates from the second market; and
wherein a third data item of the one or more data items originates from a third market.

7. A computer-executed method comprising:
determining a first feature score associated with a particular feature of data in a first data set;
determining a first subset of data, of the first data set, having the first feature score for the particular feature;
associating the first feature score with a first distribution of relevance scores associated with the first subset of data;
determining a second feature score associated with the particular feature of data in a second data set;
determining a second subset of data, of the second data set, having the second feature score for the particular feature;
associating the second feature score with a second distribution of relevance scores associated with the second subset of data;
determining whether a difference between the first distribution and the second distribution is below a specified threshold; and
in response to determining that the difference between the first distribution and the second distribution is below the specified threshold, changing the second feature score to be the first feature score;
wherein the method is performed by one or more computing devices.

8. The computer-executed method of claim 7,
wherein the step of changing the second feature score to be the first feature score further comprises changing the second feature score in each data item of the second subset of data to be the first feature score; and
the method further comprising:
determining a set of rules based at least in part on the first subset of data and the second subset of data,
creating a ranking function based at least in part on the set of rules, and
ranking one or more data items based at least in part on the ranking function.

9. The computer-executed method of claim 8,
wherein the one or more data items correspond to data items in the second data set;
wherein each data item of the one or more data items comprises a feature score for the particular feature; and
wherein the step of ranking the one or more data items further comprises:
determining whether a particular data item of the one or more data items includes the second feature score, and
in response to determining that the particular data item includes the second feature score, ranking, by the ranking function, the particular data item based at least in part on the first feature score.

10. The computer-executed method of claim 7,
wherein the data in the first data set comprises a query/document pair comprising a corresponding query and a corresponding document;
wherein the particular feature is one of: (a) a feature of the corresponding query, (b) a feature of the corresponding document, or (c) a feature of the query/document pair;
wherein the query/document pair is associated with a particular graded relevance score; and
wherein the particular graded relevance score of the query/document pair is determined by a human.

11. The computer-executed method of claim 7, further comprising:
determining a third feature score associated with the particular feature of data in the first data set;
determining a third subset of data, of the first data set, having the third feature score for the particular feature;
associating the third feature score with a third distribution of relevance scores associated with the third subset of data;
determining a fourth feature score associated with the particular feature of data in the second data set;
determining a fourth subset of data, of the second data set, having the fourth feature score for the particular feature;
associating the fourth feature score with a fourth distribution of relevance scores associated with the fourth subset of data;
determining whether a difference between the third distribution and the fourth distribution is below the specified threshold;
in response to determining that the difference between the third distribution and the fourth distribution is below the specified threshold, changing the fourth feature score to be the third feature score in the fourth subset of data;
determining a fifth feature score associated with the particular feature of data in the second data set, wherein the fifth feature score is between the second feature score and the fourth feature score;
determining a particular value based at least in part on the first feature score and the third feature score; and
changing the fifth feature score to be the particular value.

12. The computer-executed method of claim 8,
wherein the first data set originates from a first market and the second data set originates from a second market;
wherein a first data item of the one or more data items originates from the first market;
wherein a second data item of the one or more data items originates from the second market; and
wherein a third data item of the one or more data items originates from a third market.

13. One or more storage media storing instructions which, when executed by one or more computing devices, cause performance of the method recited in claim 1.

14. One or more storage media storing instructions which, when executed by one or more computing devices, cause performance of the method recited in claim 2.

15. One or more storage media storing instructions which, when executed by one or more computing devices, cause performance of the method recited in claim 3.

16. One or more storage media storing instructions which, when executed by one or more computing devices, cause performance of the method recited in claim 5.

17. One or more storage media storing instructions which, when executed by one or more computing devices, cause performance of the method recited in claim 7.

18. One or more storage media storing instructions which, when executed by one or more computing devices, cause performance of the method recited in claim 8.

19. One or more storage media storing instructions which, when executed by one or more computing devices, cause performance of the method recited in claim 9.

20. One or more storage media storing instructions which, when executed by one or more computing devices, cause performance of the method recited in claim 11.
